(19) United States
(12) Patent Application Publication
(10) Pub. No.: US 2007/0033272 A1
(43) Pub. Date: Feb. 8, 2007

(54) Dynamic subnet updates

(76) Inventors: Vasu Vallabhaneni, Austin, TX (US); Patrick Tam Vo, Houston, TX (US)

Correspondence Address: IBM CORP (YA);C/O YEE & ASSOCIATES PC, P.O. BOX 802333, DALLAS, TX, 75380, US

(21) Appl. No.: 11/197,617

(22) Filed: Aug. 4, 2005

(51) Int. Cl. G06F 15/173; G06F 15/177

(52) U.S. Cl. 709/223; 709/220

(57) ABSTRACT

A method is provided to dynamically update the subnets of a server. Subnet configuration updates are received from a user or administrator and the subnets affected by the configuration updates are determined. The clients associated with the subnets are saved to storage and the subnet configuration updates are loaded. Once the subnet configuration updates are loaded, the clients associated with the newly updated subnets are reloaded.

### BACKGROUND OF THE INVENTION

1. Field of the Invention

The present invention relates generally to the subnets of a dynamic host configuration protocol server. More particularly, the present invention relates to dynamically updating the subnets of a dynamic host configuration protocol server.

2. Description of the Related Art

Dynamic host configuration protocol (dynamic host configuration protocol) is a protocol for assigning dynamic Internet Protocol (IP) addresses to devices on a network. With dynamic addressing, a device may have a different IP address every time it connects to the network. In some systems, the device's IP address may even change while it is still connected. Dynamic host configuration protocol also supports a mix of static and dynamic IP addresses.

Dynamic addressing simplifies network administration because the software keeps track of IP addresses rather than requiring an administrator to manage the task. This means that a new computer may be added to a network without the hassle of manually assigning it a unique IP address. Dynamic host configuration protocol adds the capability of automatically allocating reusable network addresses and distributing additional host configuration options.

When the dynamic host configuration protocol server is active, it can have thousands of clients distributed over multiple subnets. Whether an administrator decides to add a new subnet, redistribute a subnet, or modify the server in any way, the administrator must alter the configuration file and then refresh the server. The reason for refreshing the server is that the server must save what it currently has in memory to disk, reread the configuration file, load saved client records, and then invalidate those clients that are no longer valid. This delay may be extensive depending on the number of clients. Additionally, when the server is busy loading the configuration and client records, the server is unable to answer awaiting clients.

### SUMMARY OF THE INVENTION

The present invention provides a method, data processing system, and computer usable code for dynamically updating a set of subnets. The present invention receives subnet configuration updates from a user or administrator and determines the subnets affected by the configuration updates. The clients associated with the subnets are saved off to storage and the subnet configuration updates are loaded. Once configuration updates are loaded, the clients associated with the newly updated subnets are reloaded.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system in which aspects of the present invention may be implemented;

FIG. 3 is a diagram depicting dynamic host configuration protocol network components in accordance with an illustrative embodiment of the present invention;

FIG. 4 is a functional block diagram of a dynamic host configuration protocol server in accordance with an illustrative embodiment of the present invention;

FIG. 5 is a diagram of the components of a subnet in accordance with an illustrative embodiment of the present invention; and

FIG. 6 is a flow diagram depicting the operation of dynamically updating one or more subnets on a dynamic host configuration protocol server in accordance with an illustrative embodiment of the present invention.

### DETAILED DESCRIPTION OF THE PREFERRED EMBODIMENT

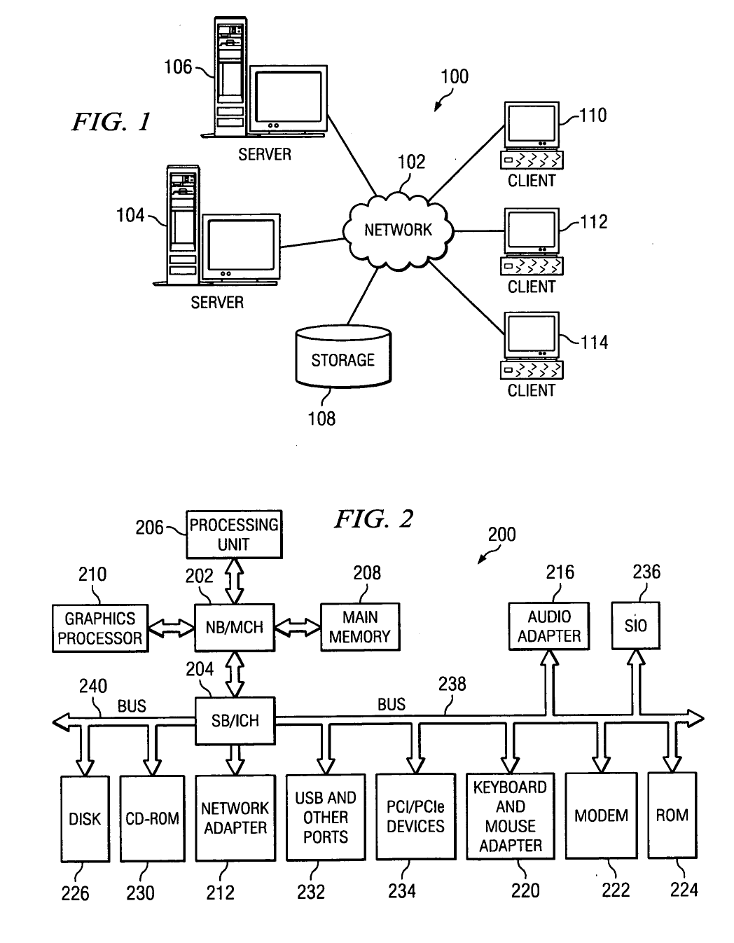

The present invention provides a method, data processing system and computer usable code for dynamically updating the subnets of a Dynamic Host Configuration Protocol server. FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or Linux™ operating system (eserver, pseries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The exemplary aspects of the present invention provide a method to dynamically update the subnets of a dynamic host configuration protocol server. Subnet configuration updates are received from a user or administrator and the subnets affected by the configuration updates are determined. The clients associated with the subnets are saved to storage and the subnet configuration updates are loaded. Once the subnet configuration updates are loaded, the clients associated with the newly updated subnets are reloaded.

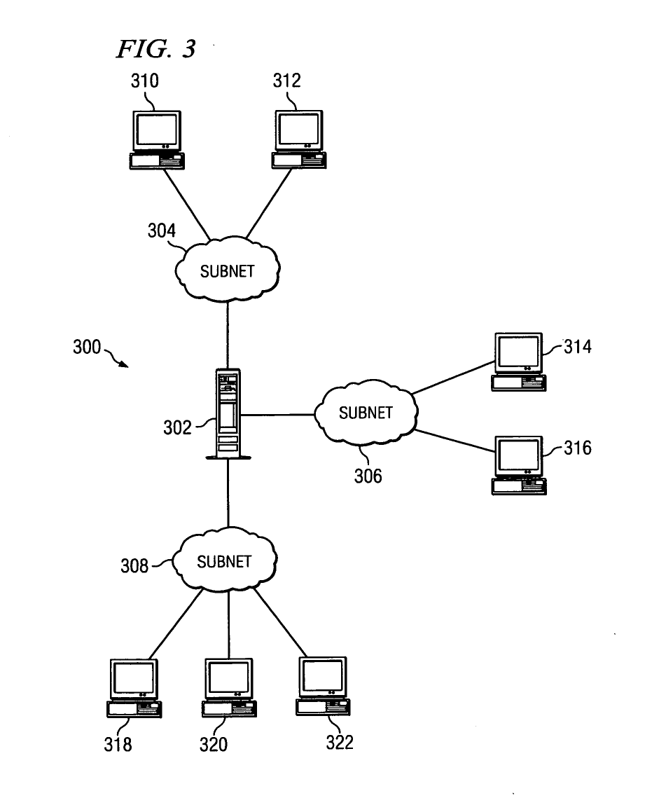

FIG. 3 is a diagram depicting dynamic host configuration protocol network components in accordance with an illustrative embodiment of the present invention. Dynamic host configuration protocol network 300 depicts dynamic host configuration protocol servers 302, subnets 304, 306, and 308, and dynamic host configuration protocol clients 310, 312, 314, 316, 318, 320, and 322. Dynamic host configuration protocol server 302 may be a server such as servers 104 and 106 of FIG. 1. Dynamic host configuration protocol clients 310, 312, 314, 316, 318, 320, and 322 may be clients such as clients 110, 112, 114 of FIG. 1. The dynamic host configuration protocol allows dynamic host configuration protocol clients 310, 312, 314, 316, 318, 320, and 322 to obtain their IP address and additional IP network configuration from dynamic host configuration protocol server 302. The IP addresses may be allocated permanently or leased for a specific time period. In the latter case, dynamic host configuration protocol clients 310, 312, 314, 316, 318, 320, and 322 have to check with dynamic host configuration protocol server 302 to re-validate the address and renew the lease on a periodic basis.

Dynamic host configuration protocol server 302 dispenses and manages network IP addresses. Dynamic host configuration protocol server 302 assigns IP addresses to dynamic host configuration protocol clients 310, 312, 314, 316, 318, 320, and 322 that are connecting to the network for the first time. When one of dynamic host configuration protocol clients 310, 312, 314, 316, 318, 320, and 322 connects to the network, dynamic host configuration protocol server 302 automatically assigns it an IP address from an appropriate pool of addresses.

Although it is possible to have multiple dynamic host configuration protocol servers on a network, the subnet pools of the dynamic host configuration protocol servers may not overlap. However, it is recommended that only one dynamic host configuration protocol server is used for an entire network. Dynamic host configuration protocol server 302 is responsible for a pool of IP addresses. This server can give out an IP address to a dynamic host configuration protocol client requesting a new configuration from the pool of IP addresses for which it is responsible. When a dynamic host configuration protocol client asks for confirmation of its existing configuration, dynamic host configuration protocol server 302 confirms the configuration.

Dynamic host configuration protocol server 302 supplies dynamic host configuration protocol clients 310, 312, 314, 316, 318, 320, and 322 with sufficient information to establish an endpoint for network communications. Dynamic host configuration protocol server 302 also supplies other parameters needed by system-level and application-level software. Dynamic host configuration protocol clients 310, 312, 314, 316, 318, 320, and 322 may include TCP/IP network printers, X terminals, and Microsoft Windows machines.

Dynamic host configuration protocol server 302 has control of the IP address block. Dynamic host configuration protocol server 302 grants dynamic host configuration protocol clients 310, 312, 314, 316, 318, 320, and 322 permission to use IP addresses on a lease basis. The IP address is “leased” to the dynamic host configuration protocol client for a fixed amount of time. The administrator sets the lease time, which can last from 120 seconds to infinity. During the lease, dynamic host configuration protocol guarantees that the IP address assigned to the dynamic host configuration protocol client will not be re-assigned to another dynamic host configuration protocol client. Before the lease time expires, dynamic host configuration protocol clients 310, 312, 314, 316, 318, 320, and 322 automatically requests an extension on its lease. As long as dynamic host configuration protocol clients 310, 312, 314, 316, 318, 320, and 322 can contact the dynamic host configuration protocol server 302, the server will renew the lease.

For example, when dynamic host configuration protocol client 310 reboots, it attempts to renew the lease it had before being powered off. If dynamic host configuration protocol client 310 was powered off when the renewal time elapsed, it can be assigned a different IP address. If the IP address is still unassigned when dynamic host configuration protocol client 310 comes back online, dynamic host configuration protocol server 302 can assign the same IP address to dynamic host configuration protocol client 310. But if dynamic host configuration protocol server 302 assigned the IP address to dynamic host configuration protocol client 320 while dynamic host configuration protocol client 310 was off-line, dynamic host configuration protocol client 310 will be assigned a different IP address.

A dynamic host configuration protocol transaction begins when a dynamic host configuration protocol client, such as dynamic host configuration protocol client 310, sends out a DHCPDISCOVER packet. This transmission is usually in the form of a broadcast packet. At minimum, the packet will contain only the dynamic host configuration protocol client's 310 hardware address. Dynamic host configuration protocol server 302 receives the DHCPDISCOVER packet. If an IP address on the dynamic host configuration protocol client 310 subnet is available and dynamic host configuration protocol server 302 is willing to grant a lease, it makes an offer by sending a DHCPOFFER packet to dynamic host configuration protocol client 310. The offer packet contains the: proposed IP address for dynamic host configuration protocol client 310, dynamic host configuration protocol server's 302 name, dynamic host configuration protocol server's 302 IP address, and other configuration information. Dynamic host configuration protocol client 310 receives the DHCPOFFER packet. Dynamic host configuration protocol client 310 might receive more than one offer if more than one dynamic host configuration protocol server is present on the network. If dynamic host configuration protocol client 310 likes the offer, this client sends a DHCPREQUEST packet to dynamic host configuration protocol server 302. This packet indicates a formal request to lease the IP address offered by dynamic host configuration protocol server 302.

Dynamic host configuration protocol server 302 receives the DHCPREQUEST packet and grants dynamic host configuration protocol client 310 its request to lease the IP address. Dynamic host configuration protocol server 302 sends a DHCPACK packet to dynamic host configuration protocol client 310. This packet is the official notification that the address has been granted. Before the lease time expires, dynamic host configuration protocol client 310 requests to extend the lease by sending a DHCPREQUEST packet to dynamic host configuration protocol server 302. Dynamic host configuration protocol server 302 then updates and extends the lease time. Dynamic host configuration protocol server 302 sends a DHCPACK to dynamic host configuration protocol client 310 to notify dynamic host configuration protocol client 310 that the lease has been extended. These updates and lease extensions continue as long as dynamic host configuration protocol client 310 is powered on. If the lease expires and dynamic host configuration protocol client 310 is not powered on, and not able to request an extension on the lease, the IP address is recycled.

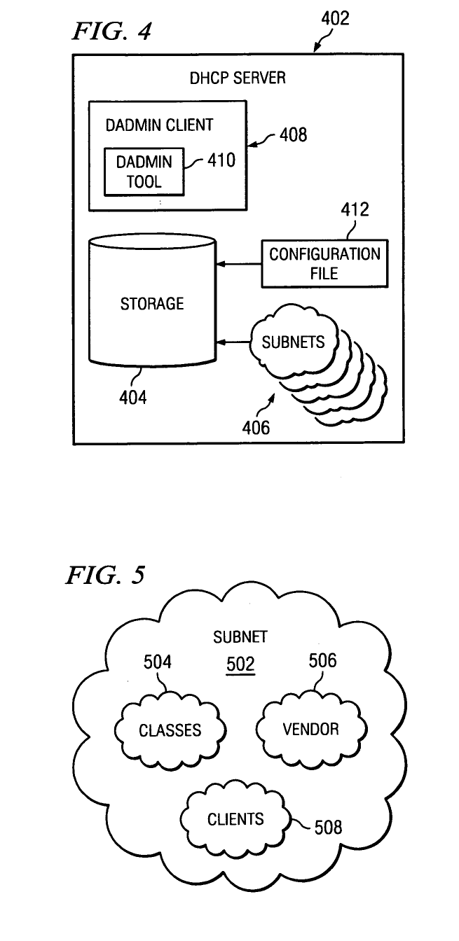

FIG. 4 is a functional block diagram of a dynamic host configuration protocol server such as dynamic host configuration protocol server 302 of FIG. 3 in accordance with an illustrative embodiment of the present invention. Dynamic host configuration protocol server 402 has many components in addition to those shown in FIG. 4. Some exemplary components are storage 404, subnets 406, dadmin client program 408, and configuration file 412. Dynamic host configuration protocol server 402 is a set of operations that are used to keep things running. Since dynamic host configuration protocol server 402 is threaded, these operations are actually set up as threads that occasionally do things to make sure everything is together. The first thread, the main thread, handles the SRC requests (such as startsrc, stopsrc, lssrc, traceson, and refresh). This thread also coordinates all operations that affect all threads and handles signals. The next thread, the dadmin thread, interfaces with dadmin client program 408 and dynamic host configuration protocol server 402. Dadmin tool 410 may be used to get status as well as modify the database to avoid editing the database files manually. Previous versions of dynamic host configuration protocol server 402 prevented any clients from getting addresses if a status request was running. With the addition of the dadmin and src threads, dynamic host configuration protocol server 402 can handle service requests and still handle client requests.

Subnets 406 and configuration file 412 may be stored on storage unit 404 of dynamic host configuration protocol server 402. Subnets 406 may be subnets, such as subnets 304, 306, 308 of FIG. 3, and storage unit 404 may be any type of data structure such as storage 108 of FIG. 1. Dadmin tool 410 interfaces with dadmin client 408 and dynamic host configuration protocol server 402. Dadmin tool 408 may be used to get status as well as modify the configuration file 412 to avoid editing database files manually. Exemplary aspects of the present invention modifies dadmin tool 410 to accept interactive commands or an input file from a user or administrator to update one or more of subnets 406.

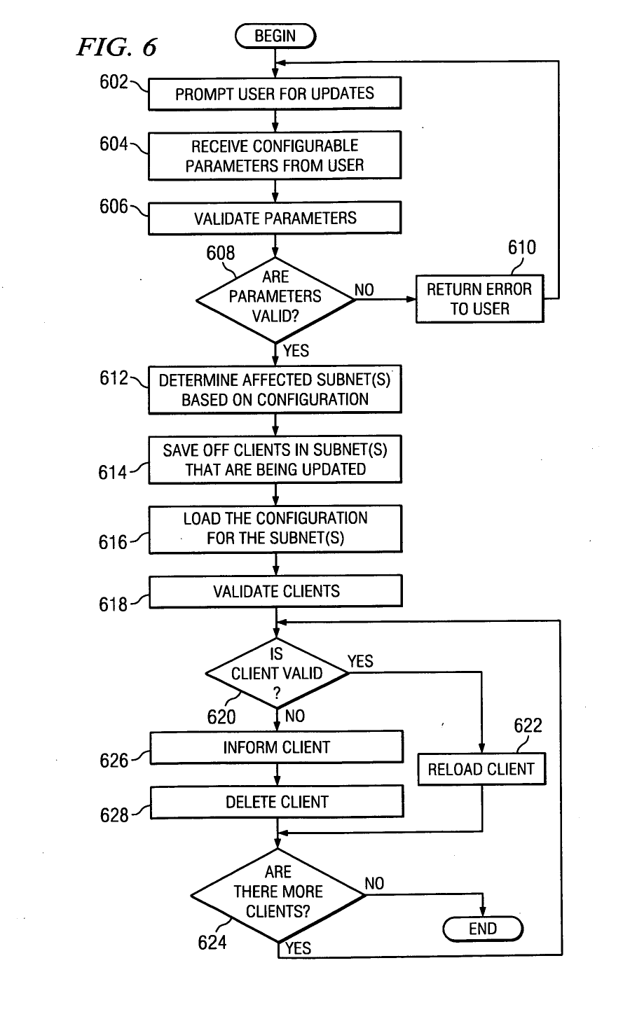

FIG. 5 is a diagram of the components of a subnet, such as subnets 304, 306, 308 of FIG. 3 and subnets 406 of FIG. 4, in accordance with an illustrative embodiment of the present invention. Subnet 502 may be a portion of a network that shares a common address component. On TCP/IP networks, subnets are defined as all devices whose IP addresses have the same prefix. For example, all devices with IP addresses that start with 100.100.100.xxx, where xxx may be any number, would be part of the same subnet. Additionally, subnet 502 is a container that may also contain other components such as classes 504, vendors 506, and clients 508.

When a dynamic host configuration protocol server is active, it can have thousands of clients distributed over multiple subnets, such as subnet 502. Whether an administrator decides to add a new subnet, redistribute a subnet, or modify the server in any way, the administrator must alter the configuration file and then refresh the dynamic host configuration protocol server. The reason for refreshing the dynamic host configuration protocol server is that the server must save what the server currently has in memory to disk, reread the configuration file, load saved client records, and then invalidate those clients that are no loner valid. This delay may be extensive depending on the number of clients. Additionally, when the dynamic host configuration protocol server is busy refreshing the configuration and client records, the dynamic host configuration protocol server is not able to answer awaiting clients.

FIG. 6 is a flow diagram depicting the operation of dynamically updating one or more subnets on a dynamic host configuration protocol server in accordance with an illustrative embodiment of the present invention. The dynamic host configuration protocol server described in this operation may be any dynamic host configuration protocol such as dynamic host configuration protocol 402 of FIG. 4. As the operation begins, the user or administrator is prompted by a dadmin tool for configuration update(s) (step 602). The dadmin tool receives the configuration update(s) from the user or administrator (step 604) and then validates those parameters associated with the configuration update(s) (step 606). If the parameters entered by the user or administrator are invalid (step 608), then the dadmin tool responds to the user or administrator with an error message (step 610). Returning to step 608, if the parameters entered by the user or administrator are syntactically valid, then the dadmin tool will send the update to the dynamic host configuration protocol server. The server will determine the subnets that are affected by the configuration update(s) (step 612).

The clients associated with the one or more subnets that are being updated are then saved off (step 614). The client may be saved to any data structure such as storage 404 of FIG. 4. Saving off the clients is performed by looking in the subnet as well as any class and sub-containers of the subnet to determine all clients affected and saving the client information to storage. The operation then proceeds to load the configuration update(s) specified by the user or administrator and validated by the dynamic host configuration protocol server (step 616). The dynamic host configuration protocol server then validates the clients that were previously saved off to determine if they are still associated with the newly configured subnets (step 618). Based on the configuration updates clients may not be validated for various reasons, for example, that the client's IP address has expired, the client no longer belongs to the newly updated subnet container, or the clients IP address has moved to another subnet container. If the client has been validated as being part of the newly configured subnet container (step 620), then the client is reloaded (step 622).

A determination is then made as to whether there are additional clients to validate (step 624). If there are additional clients, then the operation returns to step 620, otherwise the operation ends. Returning to step 620, if the invalid client is no longer part of the newly configured subnet container, then the client is informed of their IP address being terminated (step 626), the client deleted from the subnet (step 628), and the operation proceeds to step 624.

Thus, the illustrative aspects of the present invention provide a method, apparatus, and computer usable code to dynamically update the subnets of a dynamic host configuration protocol server. Subnet configuration updates are received from a user or administrator and the subnets affected by the configuration updates are determined. The clients associated with the subnets are saved to storage and the subnet configuration updates are loaded. Once the subnet configuration updates are loaded, the clients associated with the newly updated subnets are reloaded.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in a server for dynamically updating configuration information, the computer implemented method comprising:
receiving updated configuration information;
identifying a set of subnets from a plurality of subnets managed by the server;
saving information for clients in the set of subnets to form saved client information;
updating the set of subnets with the updated configuration information to form a set of updated subnets without resetting the server; and
reloading the saved client information for the set of updated subnets without resetting the server.

2. The computer implemented method of claim 1, further comprising:
prompting a user for configuration information; and
receiving the configuration information from the user to form the updated configuration information.

3. The computer implemented method of claim 2, wherein the user is prompted through a modified dadmin tool.

4. The computer implemented method of claim 1, further comprising:
validating a set of parameters associated with the updated configuration information.

5. The computer implemented method of claim 4, further comprising:
responsive to an invalid parameter within the set of parameters, sending an error message to the user.

6. The computer implemented method of claim 1, further comprising:
validating the clients as belonging to the newly updated set of subnets.

7. The computer implemented method of claim 6, further comprising:
responsive to a client within the clients no longer belonging to the set of updated subnets, informing a user of the client that an IP address associated with the client is being terminated; and
deleting the IP address.

8. The computer implemented method of claim 1, wherein the server is dynamic host configuration protocol server.

9. A data processing system comprising:
a bus system;
a communications system connected to the bus system;
a memory connected to the bus system, wherein the memory includes a set of instructions; and
a processing unit connected to the bus system, wherein the processing unit executes the set of instructions to receive updated configuration information; identify a set of subnets from a plurality of subnets managed by the server; save information for clients in the set of subnets to form saved client information; update the set of subnets with the updated configuration information to form a set of updated subnets without resetting the server; and reload the saved client information for the set of updated subnets without resetting the server.

10. The data processing system of claim 9, further comprising:
a set of instructions to prompt a user for configuration information; and receive the configuration information from the user to form the updated configuration information.

11. The data processing system of claim 9, further comprising:
a set of instructions to validate a set of parameters associated with the updated configuration information.

12. The data processing system of claim 11, further comprising:
a set of instructions to send an error message to the user in response to an invalid parameter within the set of parameters.

13. The data processing system of claim 9, further comprising:
a set of instructions to validate the clients as belonging to the newly updated set of subnets.

14. The data processing system of claim 13, further comprising:
a set of instructions to inform a user of the client that an IP address associated with the client is being terminated in response to a client within the clients no longer belonging to the set of updated subnets; and delete the IP address.

15. A computer program product comprising:
a computer usable medium including computer usable program code for bulk deletion through segmented files, the computer program product including;
computer usable program code for receiving updated configuration information;
computer usable program code for identifying a set of subnets from a plurality of subnets managed by the server;
computer usable program code for saving information for clients in the set of subnets to form saved client information;
computer usable program code for updating the set of subnets with the updated configuration information to form a set of updated subnets without resetting the server; and
computer usable program code for reloading the saved client information for the set of updated subnets without resetting the server.

16. The computer program product of claim 15, further comprising:
computer usable program code for prompting a user for configuration information; and
computer usable program code for receiving the configuration information from the user to form the updated configuration information.

17. The computer program product of claim 15, further comprising:
computer usable program code for validating a set of parameters associated with the updated configuration information.

18. The computer program product of claim 17, further comprising:
computer usable program code for sending an error message to the user in response to an invalid parameter within the set of parameters.

19. The computer program product of claim 15, further comprising:
computer usable program code for validating the clients as belonging to the newly updated set of subnets.

20. The computer program product of claim 19, further comprising:
computer usable program code for, informing a user of the client that an IP address associated with the client is being terminated in response to a client within the clients no longer belonging to the set of updated subnets; and
computer usable program code for deleting the IP address.
